(19) United States
(12) Patent Application Publication
(10) Pub. No.: US 2001/0048555 A1
(43) Pub. Date: Dec. 6, 2001

(54) Device for generating a 3-D image from two 2-D pictures

(76) Inventor: Chih-Hao Yiu, Tatchung City (TW)

Correspondence Address: Hart, Baxley, Daniels & Holton, 59 John Street, Fifth Floor, New York, NY, 10038, US

(21) Appl. No.: 09/922,582

(22) Filed: Aug. 6, 2001

Related U.S. Application Data
(63) Continuation-in-part of application No. 09/573,948, filed on May 19, 2000.

(51) Int. Cl. G02B 27/24; G02B 27/22

(52) U.S. Cl. 359/466; 359/464

(57) ABSTRACT

A device for generating a 3-D image includes a tubular body with liquid filled therein and two convex-concave members extrude from one side of the body. Two stereoscopic pictures are located on another side opposite to the side having the two convex-concave members. A 3-D image is seen when viewing the two pictures via the two convex-concave members.

### FIELD OF THE INVENTION

This application is a Continuation-In-Part application of applicant's former U.S. patent application Ser. No. 09/573,948.

### BACKGROUND OF THE INVENTION

FIG. 6 illustrates how our eyes 16 distinguish the distances between two objects 10, 11 from the eyes 16. An angle 17 between our two eyes 16 and the object 10/11 is called “optical angle” which decides the distance that the viewer feels. A larger optical angle means a distance between the object and the eyes 16 is longer than a distance between the object and the eyes with a smaller optical angle. Referring to FIG. 7, an angle between the eye 16 and an outer periphery of an object 12/13 is called “visual angle” 15/14. A larger visual angle means a larger object. FIG. 8 shows a conventional means 20 for generating a 3-D image. The means 20 has two lenses 21, 22 which are flashed and darkened alternatively when viewing an object. In other words, only one image message is sent to the user's brain at a time and the image messages viewed from the two lenses 21, 22 are sent to the user's brain alternatively because the operation of the two lenses 21, 22. The user's brain will combine the image messages alternatively sent according to the images viewed from the two lenses 21, 22 into a 3-D image. The means has a complicated structure and is expensive so that it is not affordable for most of the users. Furthermore, the means 20 can only provide the function for one person who wears the means 20.

The present invention intends to provide a simple device to generate a 3-D image by viewing from two convex-concave members on a bottle.

### SUMMARY OF THE INVENTION

In accordance with one aspect of the present invention, there is provided a device for generating a 3-D image by viewing two stereoscopic 2-D pictures. The device comprises a body filled with liquid and two convex members extend from an outside of the body. Two concave-concave members are defined in an inside of the body and respectively define the two concave-concave members. Two stereoscopic pictures are put on an opposite side to the concave-concave members of the body. A 3-D image is obtained when viewing from the concave-concave members.

The object of the present invention is to provide simple device that can generate a 3-D image from two 2-D pictures.

These and further objects, features and advantages of the present invention will become more obvious from the following description when taken in connection with the accompanying drawings which show, for purposes of illustration only, two embodiment in accordance with the present invention.

### BRIEF DESCRIPTION OF THE DRAWINGS

FIG. 1 is a perspective view to show the device of the present invention wherein a section of the tubular body is removed for illustrative purpose;

FIG. 2 is an illustrative view to show that an overlapped portion “C” is formed between two images viewed from the two concave-concave members of the device of the present invention;

FIG. 3 is an illustrative view to show how a depth of field of a 3-D image can be achieved in the device of the present invention;

FIG. 4 shows two support plates are used to position the two pictures on the plain surface of the device;

FIG. 5 is a cross sectional view to show another embodiment of the device of the present invention;

FIG. 6 shows that a distance between an object and eyes is proportional to an optical angle between the object and the eyes;

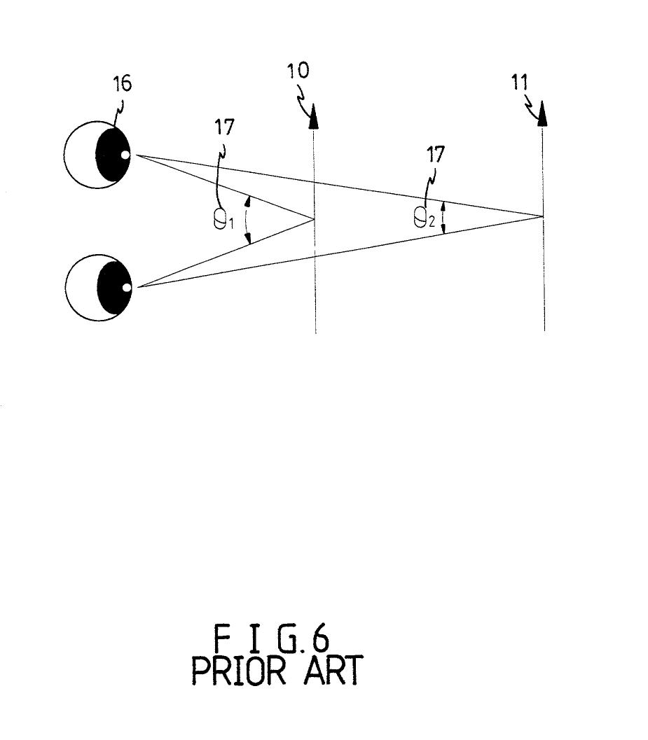

FIG. 7 shows that a size of an object is proportional to a visual angle between an outer periphery and an eye, and

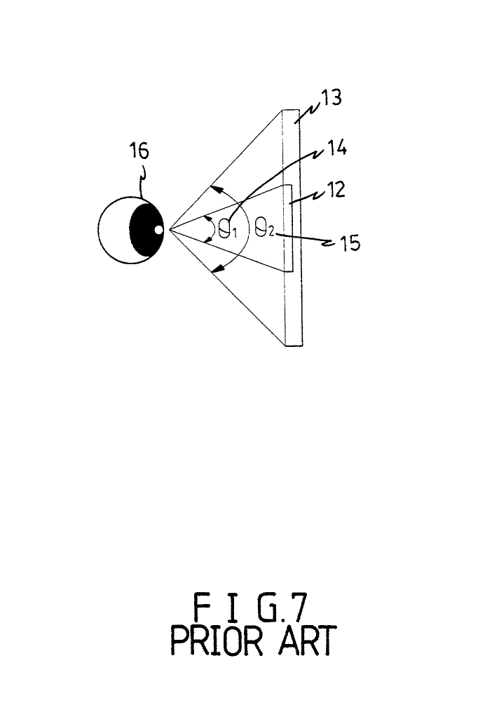

FIG. 8 is a perspective view to show a conventional means for generating a 3-D image.

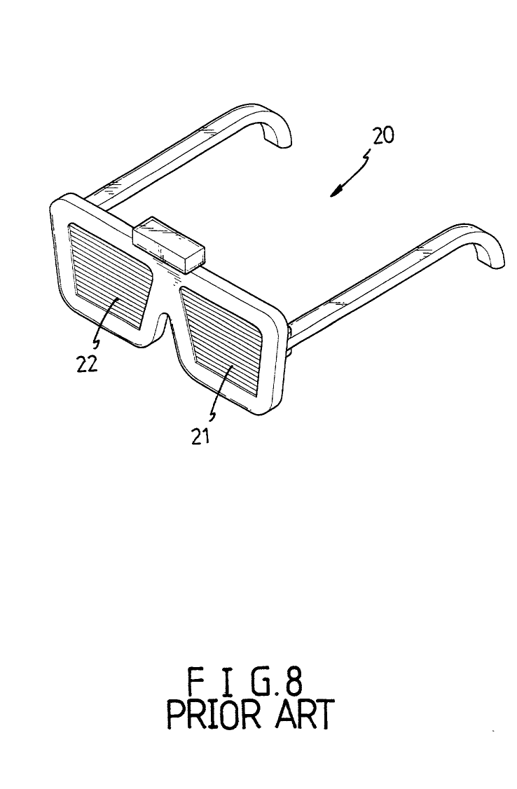

### DETAILED DESCRIPTION OF THE PREFERRED EMBODIMENTS

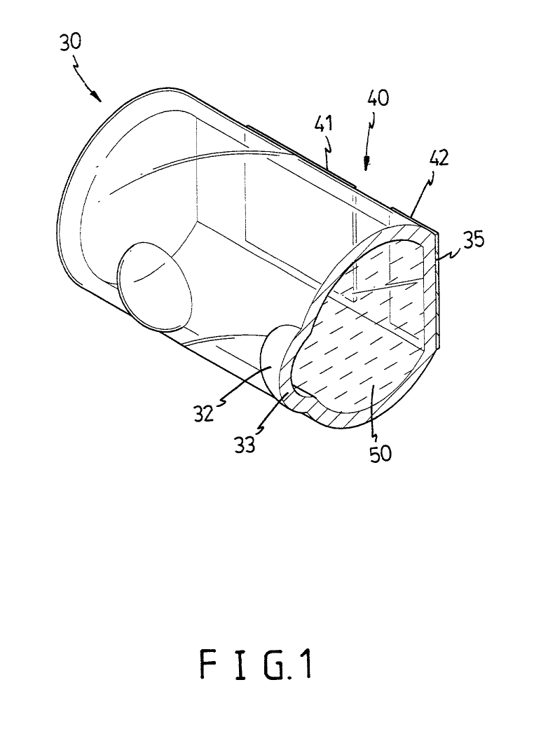

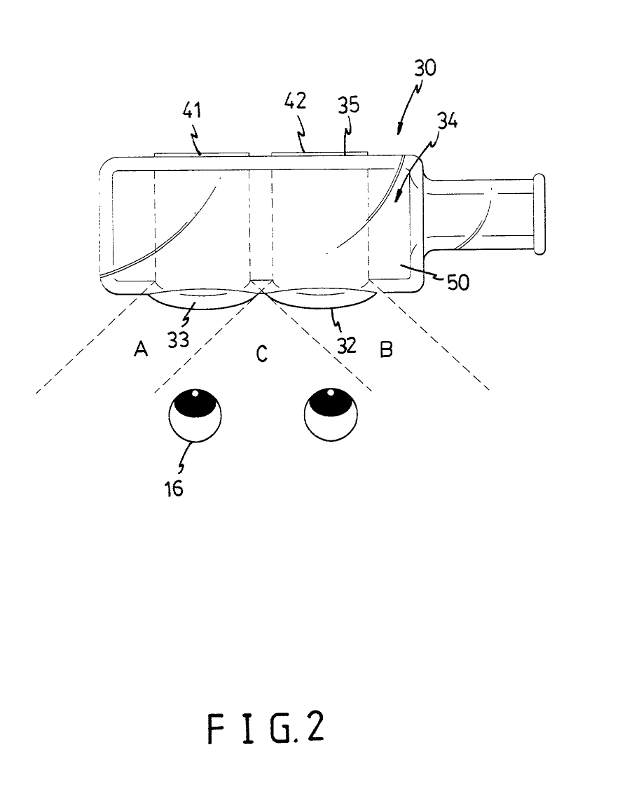

Referring to FIGS. 1 and 2, the device for generating a 3-D image in accordance with the present invention comprises a hollow transparent tubular body 30 which can be a transparent bottle having an interior 34 in which liquid 50 such as water is filled. Two convex-concave members 33 are formed on one side of the tubular body 30 and each convex-concave member 33 is formed directly from the body 30. In other words, each convex-concave member 33 has a convex outer surface 32 on an outside of the tubular body 30 and a concave portion defined in an inside of the body 30. The convex-concave members 33 each have a unique thickness. A plain surface 35 is defined on the outside of the tubular body 30 and located on an opposite side of the convex-concave members 33. Two 2-D stereoscopic pictures 41, 42 are connected to the plain surface 35. A viewer views the two pictures 41, 42 from the outside of the tubular body 30 via the two convex-concave members 33. As shown in FIG. 2, area “A” represents the image viewed via the concave-concave member 33 on the left side in FIG. 2. Area “B” represents the image viewed via the convex-concave member 33 on the right side in FIG. 2. An overlapped portion “C” is formed between the two images “A” and “B”, and the image “C” will be a 3-D image. The water reflects the direction of light when the viewer views from the convex-concave members 33.

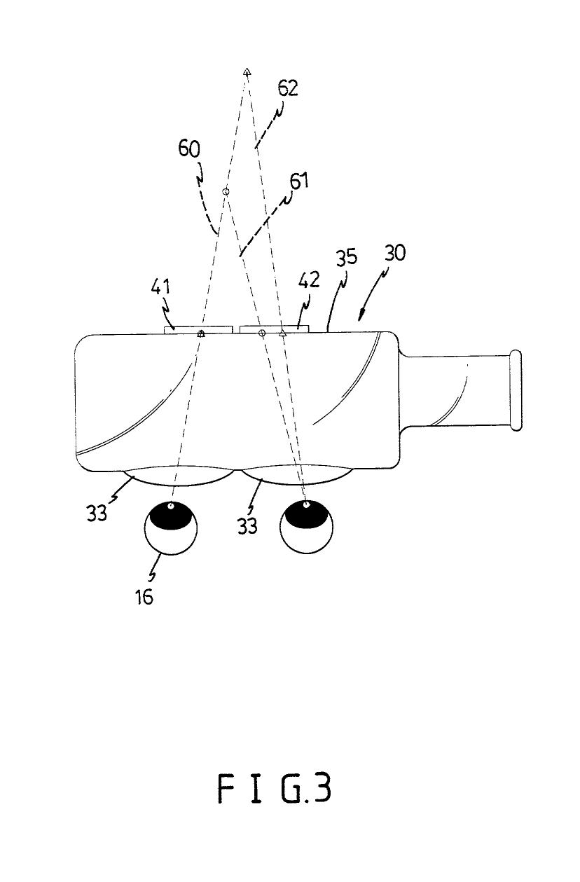

As shown in FIG. 3, if an object that the two eyes view has a triangle point and a circle point. The triangle point and the circle point are assumed to be located at the identical point on the picture 41 obtained in left eye of the viewer. The triangle point and the circle point are separated on the picture 41 obtained in right eye of the viewer because of parallax. When the two pictures 41, 42 are located on the plain surface 35, a view line 60 is established by connecting the identical point on picture 41 and the left eye 16. Another view line 61 is established by connecting the circle point on picture 42 and the right eye 16, and an image for the circle point will be presented on the spot where the two view lines 60 and 61 intersects. Yet another view line 62 is established by connecting the triangle point on picture 42 and the right eye 16, and an image for the triangle point will be presented on the spot where the two view lines 60 and 62 intersects. Therefore, there is a distance or depth between the circle and the triangle on view line 60 so that the viewer sees a 3-D image.

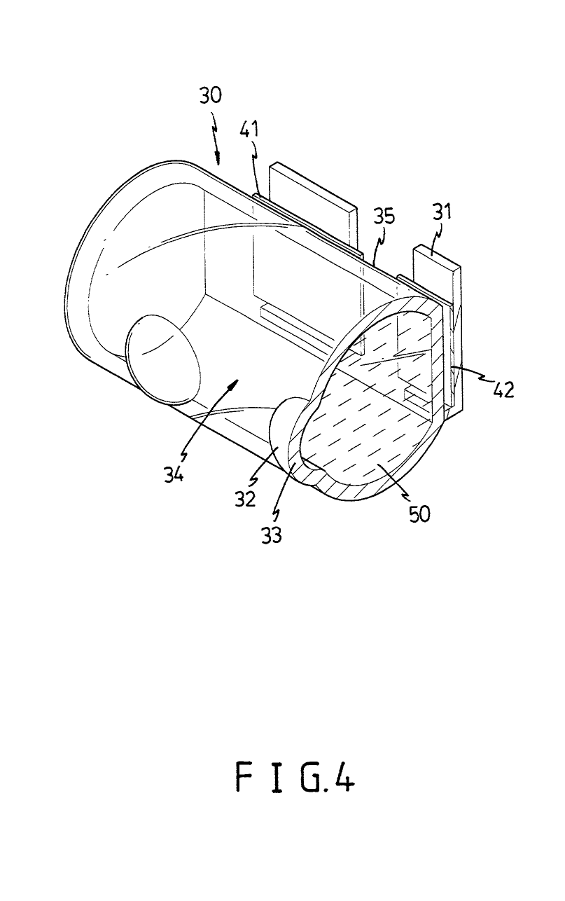

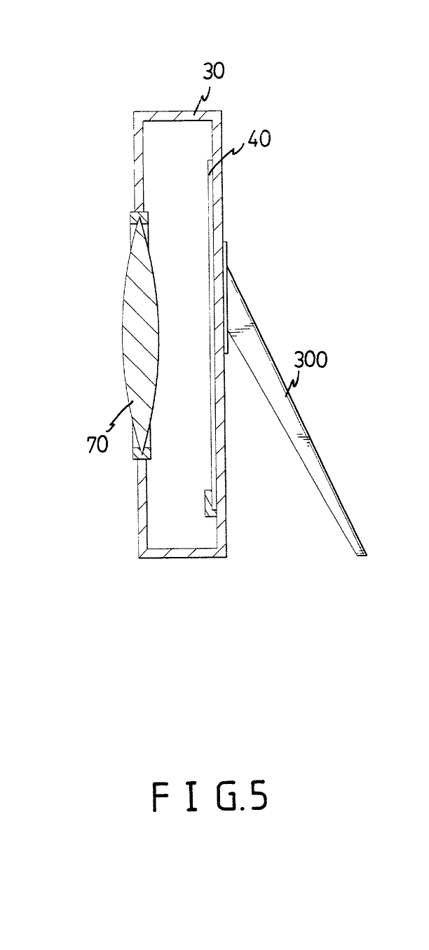

Referring to FIG. 4, two support plates 31 are put behind the tubular body 30 and a gap is defined between the plain surface 35 and the support plates 31. The two stereoscopic pictures 41, 42 are clamped to be positioned between the two support plates 31 and the plain surface 35. FIG. 5 shows that the tubular body 30 can be a frame wherein a picture 40 is attached to an inside of the frame and a convex-convex member 70 is located on an opposite side of the picture 40. A support leg 300 is connected to a rear side of the frame.

By the device of the present invention, a 3-D image is easily to get and very limited cost is required. The pictures 41, 42 may also be integrally formed to the body 30 or by any known method.

While we have shown and described various embodiments in accordance with the present invention, it should be clear to those skilled in the art that further embodiments may be made without departing from the scope of the present invention.

What is claimed is:

1. A device for generating a 3-D image comprising:
a hollow tubular body in which liquid is filled;
two convex-concave members protruding from an outside of a first side of said body and each of said convex-concave members having a unique thickness, a plain surface defined in a second side which is in opposite with said first side having said two convex-concave members;
two stereoscopic pictures located on said second side.

2. The device as claimed in claim 1, wherein two support plates are connected to said tubular body and a gap is defined between said plain surface and said support plate, said two stereoscopic pictures located in said two respective gaps.
